(19) United States
(12) Patent Application Publication
(10) Pub. No.: US 2019/0205832 A1
(43) Pub. Date: Jul. 4, 2019

(54) SYSTEM AND METHOD FOR DELIVERING PACKAGES

(71) Applicant: Ship Safe Neighbor, LLC, Canton, OH (US)

(72) Inventor: Kenneth Eugene Henderson, II, Canton, OH (US)

(21) Appl. No.: 16/233,615

(22) Filed: Dec. 27, 2018

Related U.S. Application Data
(60) Provisional application No. 62/611,021, filed on Dec. 28, 2017.

(51) Int. Cl. G06Q 10/08; G06Q 30/06

(52) U.S. Cl. CPC G06Q 10/0836; G06Q 30/0643; G06Q 10/0832

(57) ABSTRACT

A system and method for ensuring delivery of packages to a designated consignee on behalf of a consignee/customer via a carrier from a consignor is provider. A checkout module in a virtual storefront enables the customer to designate a designated consignee in order to ensure that their package(s) arrive safely and will not be stolen from the front porch when left by a carrier. The system and associated method greatly reducing shipping costs incurred by the carrier during the “last mile” of a package transit. The designated consignee may indicated their availability timeframe via a website or mobile application that interfaces with a shipping menu in a checkout module of the virtual storefront.

### CROSS REFERENCE TO RELATED APPLICATIONS

This application claims the benefit of U.S. Provisional Application Ser. No. 62/611,021, filed on Dec. 28, 2017; the disclosure of which is incorporated herein by reference.

### TECHNICAL FIELD

The present disclosure relates to computer systems implementing personalized parcel or package delivery. More particularly, the present disclosure relates to a shipping option that may be implemented in a checkout module of a virtual storefront in conjunction with a third party application interfaced with the checkout module to enable a user of the application to act as a designated consignee of an online retailer shipping purchased items in parcels or packages.

### BACKGROUND

The package delivery business typically involves three main entities in the course of delivering a package: a carrier, a consignor, and a consignee. The carrier typically arranges the delivery of a package between the consignor and the consignee, and is often referred to as a package delivery provider, service provider, or common carrier. Some exemplary carriers include United Parcel Service (UPS), FedEx Corporation (FedEx), and the United States Postal Service (USPS). The consignor is the entity that causes the package to shipped, and can be referred to as the shipper or originator, and is commonly an online retailer or seller, such as Amazon. The intended recipient of the package is the consignee, typically a purchaser or consumer who purchased the product online. Stated otherwise, in the case of a package being shipped as part of a mail-order or Internet-based purchase, typically the consignor is the merchant and the consignee is the customer of the merchant.

The process of delivering a package is well known. Typically, the consignor prepares the item to be shipped, selects a carrier and class of service (e.g., normal or expedited delivery), and arranges for the carrier to gain custody of the package. This may occur by the consignor bringing the package to a carrier's pickup location or arranging the carrier to pick up the package at the consignor's premises. Once the carrier takes possession, the carrier routes the package to a handling facility in the town or serving area of the consignee. The package is then delivered to the consignee, usually using a delivery vehicle.

Typically, the carrier maintains a regular route for the delivery of packages, and along the route will stop at the appropriate consignee's address and attempt to deliver the package. In an optimal delivery experience, the carrier delivers the package on the initial attempt to the consignee, who is present to accept the package.

However, as can be expected, in many instances the delivery experience is not optimal in that the package is not successfully delivered on the initial attempt. There are a number of reasons why this may occur. A common reason is that the consignee is not present, and therefore unable to receive and sign for the package. In some circumstances, this may not be a problem because the delivery location is determined to be secure and/or the class of service associated with the delivery may not require a signature. For example, a class of service may not require a consignee's signature for delivery or a secure lockbox may be provided for deposit of the package. However, in many instances, the class of service (or other constraints) requires a recipient to be present to accept and sign for delivery. This results in the consignee and the carrier entering into various procedures to coordinate a follow-up delivery attempt.

For large scale carriers handling millions of deliveries each day, each failed delivery attempt requires additional time and resources for coordinating a follow-up delivery attempt. Not only does this result in decreased efficiency for the carrier, but it results in an undesirable delivery experience for the consignee, and potentially the consignor as the package is not delivered as soon as it could be.

Typically, the “last mile” of delivery is most costly for the carrier in effecting delivery of the package due to the likelihood of failed delivery attempts. Thus, in order to effect an optimal delivery experience, coordination is required between the consignor, carrier, and consignee. All the parties have an interest in achieving prompt delivery.

Additionally, albeit unfortunately, “porch pirates” are becoming all too common in today's society. A porch pirate, as it is colloquially known, is a person or group of persons who steal packages off of unsuspecting customer porches or front door areas, or other areas around the home. Recent attempts have been made to create fake parcels or packages that act as traps to bait the porch pirate into stealing a package from a front porch and then captures the information of the porch pirate to provide their identifying information to local authorities to arrest or otherwise discipline the porch pirate. However, these parcel traps to catch a porch pirate are often expensive and quite vindictive.

### SUMMARY

Issues continue to exist with optimal delivery and communication between the consignor, carrier, and consignee. Additionally, issues continues to exist for an improved shipping method that circumvents porch pirates and ensures that a package ordered by a customer will be received and retained by a designated consignee. Thus, a need continues to exist for an improve delivery system that enables the carrier to deliver the package to a third-party consignee designated by the original consignee. The present disclosure addresses these and other issues by providing a safe and secure neighbor designated as a third party consignee which operates on an on-demand basis to accept deliveries from the carrier on behalf of the original consignee.

In accordance with one aspect, an exemplary embodiment of the present disclosure may include at least one non-transitory computer readable storage medium having instructions encoded thereon that, when executed by one or more processors, implement a set of operations as substantially described herein to effectuate a carrier to deliver a package that is owned by a consignee to be delivered to a designated consignee, wherein the consignee selects the designated consignee to receive the package during a checkout module portion of an online ordering process for a product or item, wherein the consignee selects the designated consignee in response to reviewing an availability of the designated consignee for retrieving the package, wherein the designated consignee is a residential address in proximity to a home address of the consignee.

In accordance with another aspect, an exemplary embodiment of the present disclosure may provide at least one non-transitory computer readable storage medium having instructions encoded thereon that, when executed by at least one processor, implement operations to activate an operator as a designated consignee to receive a package or parcel containing a purchased item by a customer from a consignor, the operations including: set, by the operator as the designated consignee, an available timeframe during which a carrier may deliver the package or parcel to the designated consignee on behalf of the customer; populate the available timeframe into a checkout module associated with a virtual storefront of the consignor; effectuate the customer to have the consignor instruct the carrier to deliver the package or parcel during the available timeframe; and an on-demand timeframe different the from available timeframe that is activated by the designated consignee in response to an execution call to notify the consignor or the carrier that the designated consignee is available to receive packages or parcels on behalf of customers.

In accordance with another aspect, an exemplary embodiment of the present disclosure may provide a method comprising: providing, by a consignor, a virtual storefront that sells items to be purchased by at least one customer; providing a virtual checkout module to allow the at least one customer to purchase items from the virtual storefront to complete a commercial transaction; effecting, during a virtual checkout process in the virtual checkout module, the at least one customer to select a shipping address of a designated consignee that is different from a home address of the at least one customer; packaging the purchased items or effecting the purchased items to be packaged into a parcel or package; effecting a carrier to ship the purchased items of the at least one customer to the designated consignee; and effecting the at least one customer to retrieve the purchased items from the designated consignee. In one instance the designated consignee is a residential neighbor of the at least one customer.

### BRIEF DESCRIPTION OF THE SEVERAL VIEWS OF THE DRAWINGS

At least one sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic view of an exemplary computing environment implementing aspects of a shipping system in accordance with the present disclosure.

FIG. 2 is a diagrammatic view of a shipping system in accordance with the present disclosure.

FIG. 3 is a diagrammatic view of the shipping system when a package is delivered to a third party or designated consignee.

FIG. 4 is a diagrammatic view of a handheld computer or smartphone depicting a portion of an online shopping module.

FIG. 5 is diagrammatic view of the handheld computer or smartphone depicting a selection between various shipping methods, where one of the shipping methods is to a “ship safe neighbor” acting as the designated consignee.

FIG. 6A is a diagrammatic view of the handheld computer or smartphone depicting a map that is populated in response to the selection of the “ship safe neighbor” detailing the available designated consignees.

FIG. 6B is a diagrammatic view of the handheld computer or smartphone depicting a list that is populated in response to the selection of the “ship safe neighbor” detailing the available designated consignees.

FIG. 7 is a diagrammatic view of the handheld computer or smartphone depicting a pop-up profile of the designated consignee.

FIG. 8 is a diagrammatic view of the handheld computer or smartphone depicting a portion of a shipping summary in the checkout module.

FIG. 9 is a diagrammatic view of the handheld computer or smartphone depicting an exemplary profile creation module to register as a designated consignee or ship safe neighbor.

FIG. 10 is a diagrammatic view of the handheld computer or smartphone depicting a selectively chosen availability or working hours.

FIG. 11 is a diagrammatic view of the handheld computer or smartphone depicting an icon that may be tapped to launch the application of the designated consignee.

FIG. 12 is a diagrammatic view of the handheld computer or smartphone depicting an on-demand or as-need designated consignee.

FIG. 13 is a diagrammatic view of the handheld computer or smartphone depicting a return shipping ability for the designated consignee to receive packages for outgoing shipments.

Similar numbers refer to similar parts throughout the drawings.

### DETAILED DESCRIPTION

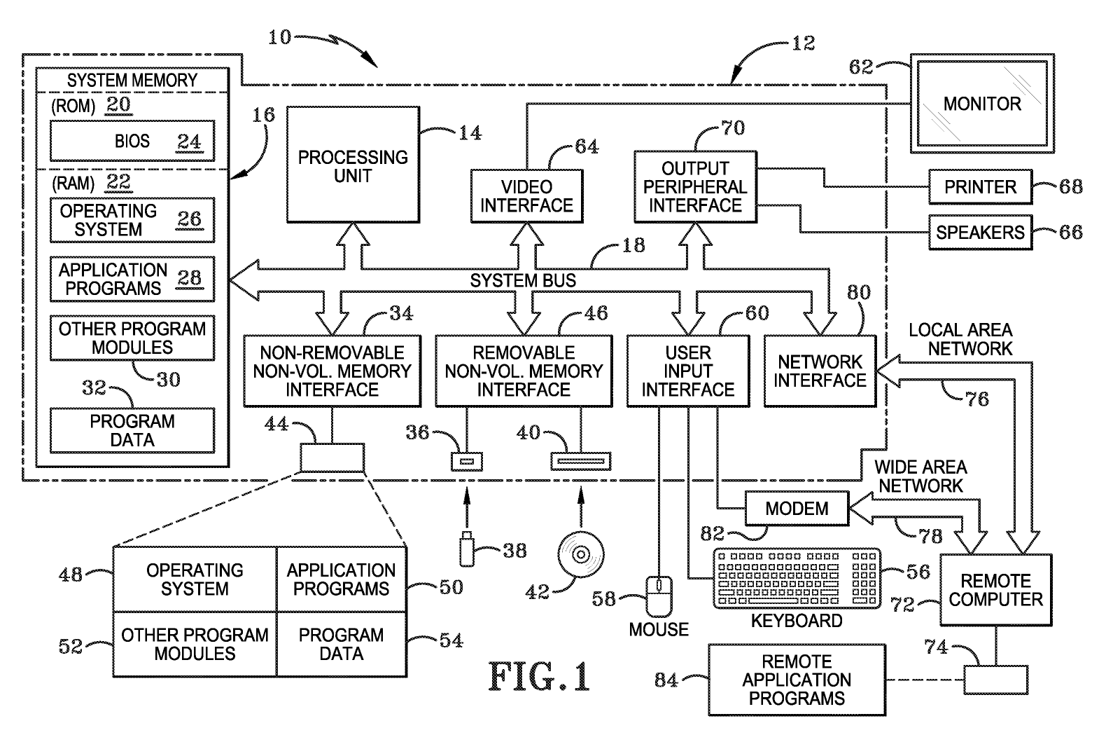

FIG. 1 depicts an exemplary computing system environment 10 which is constructed to execute instructions and interface with an operator. The computing system environment 10 includes a computer or apparatus on which the claimed method and programmed memory may be implemented. The computing system environment 10 is only one example of a suitable computing environment and is not intended to suggest any limitation as to the scope of use or functionality of the invention. Neither should the computing environment 10 be interpreted as having any dependency or requirement relating to any one or combination of components illustrated in the exemplary operating computing system environment 10. Notably, computing system environment 10 may be any computing device, such as a mobile device (i.e., smartphone or tablet), a laptop computer, or a desktop computer, or any other device capable of internet web browsing.

The claimed methods, programmed memory and apparatus are operational with numerous other general purpose or spatial purpose computing system environments or configurations. Examples of well-known computing systems, environments, and/or configurations that may be suitable for use with the invention include, but are not limited to, personal computers, server computers, hand-held or laptop devices, smart phones (such as an Apple iPhone or a Samsung Galaxy or the like), multiprocessor systems, microprocessor-based systems, set top boxes, programmable consumer electronics, network PCs, minicomputers, mainframe computers, distributed computing environments that include any of the above systems or devices, and the like.

The claimed methods, apparatus and programmed memory may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the claimed methods, apparatus and programmed memory includes a general purpose computing device in the form of a computer 12. Components of computer 12 may include, but are not limited to, a processing unit or processor 14, a system memory 16 (which may also be referred to as a non-transitory computer readable storage medium), and a system bus 18 that couples various system components including the system memory to the processing unit 14. The system bus 18 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 12 typically includes a variety of computer readable media. Computer readable media can be any available media that can be accessed by computer 12 and includes both volatile and nonvolatile media, transitory and non-transitory, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. This may also include non-transitory computer readable storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 16 includes computer storage media in the form of volatile and/or nonvolatile memory such as read only memory (ROM) 20 and random access memory (RAM) 22. A basic input/output system 24 (BIOS), including the basic routines that help to transfer information between elements within computer 12, such as during start-up, is typically stored in ROM 20. RAM 22 typically includes data and/or program modules that are immediately accessible to and/or presently being operated on by processing unit 14. By way of example, and not limitation, FIG. 1 illustrates operating system 26, application programs 28, other program modules 30, and program data 32.

The computer 12 may also include other removable/non-removable, volatile/nonvolatile computer storage media. By way of example only, FIG. 1 illustrates a hard disk drive 44 that reads from or writes to non-removable, nonvolatile magnetic media, a drive 36 that reads from or writes to a removable, nonvolatile magnetic disk or USB flash drive 38, and an optical disk drive 40 that reads from or writes to a removable, nonvolatile optical disk 42 such as a CD ROM or other optical media. Other removable/non-removable, volatile/nonvolatile computer storage media that can be used in the exemplary operating environment include, but are not limited to, magnetic tape cassettes, USB thumb drives, USB memory sticks, SD cards, flash memory cards, digital versatile disks, digital video tape, solid state RAM, solid state ROM, and the like. The hard disk drive 44 is typically connected to the system bus 18 through a non-removable memory interface such as interface 34, and drive 36 and optical disk drive 40 are typically connected to the system bus 18 by a memory interface, such as interface 46.

The drives and their associated computer storage media discussed above and illustrated in FIG. 1, provide storage of computer readable instructions, data structures, program modules and other data for the computer 12. In FIG. 1, for example, hard disk drive 44 is illustrated as storing operating system 48, application programs 50, other program modules 52, and program data 54. Note that these components can either be the same as or different from operating system 26, application programs 28, other program modules 30, and program data 32. Operating system 48, application programs 50, other program modules 52, and program data 54 are given different numbers here to illustrate that, at a minimum, they are different copies.

A user may enter commands and information into the computer 12 through input devices such as a keyboard 56 and pointing device 58, commonly referred to as a mouse, trackball, touch pad or touch screen. Other input devices (not shown) may include a touchscreen, buttons, individual keys, microphone, joystick, game pad, satellite dish, scanner, or the like. These and other input devices are often connected to the processing unit 14 through a user input interface 60 that is coupled to the system bus 18, but may be connected by other interface and bus structures, such as a parallel port, game port or a universal serial bus (USB). A monitor 62 or other type of display device is also connected to the system bus 18 via an interface, such as a video interface 64. In addition to the monitor 62, computers may also include other peripheral output devices such as speakers 66 and printer 68, which may be connected through an output peripheral interface 70.

The computer 12 may operate in a networked environment using logical connections or other logic to one or more remote computers, such as a remote computer 72. The remote computer 72 may be a personal computer, a server, a router, a network PC, a peer device, a smartphone or other common network node, and typically includes many or all of the elements described above relative to the computer 12, although only a memory storage device 74 has been illustrated in FIG. 1. The logical connections depicted in FIG. 1 include a local area network (LAN) 76 and a wide area network (WAN) 78, but may also include other networks. Such networking environments are commonplace in offices, enterprise-wide computer networks, intranets and the Internet.

When used in a LAN networking environment, the computer 12 is connected to the LAN 76 through a network interface or adapter 80. When used in a WAN networking environment, the computer 12 typically includes a modem 82 or other means for establishing communications over the WAN 78, such as the Internet. The modem 82, which may be internal or external, may be connected to the system bus 18 via the user input interface 60, or other appropriate mechanism. In a networked environment, program modules depicted relative to the computer 12, or portions thereof, may be stored in the remote memory storage device. By way of example, and not limitation, FIG. 1 illustrates remote application programs 84 as residing on memory device 74. It will be appreciated that the network connections shown are exemplary and other means of establishing a communications link between the computers may be used.

Now that computing environment 10 has been described, reference is made to the accounting system, method, and article of manufacture for enabling accounting principles to be performed of the present disclosure, to which the computing environment 10 helps implement.

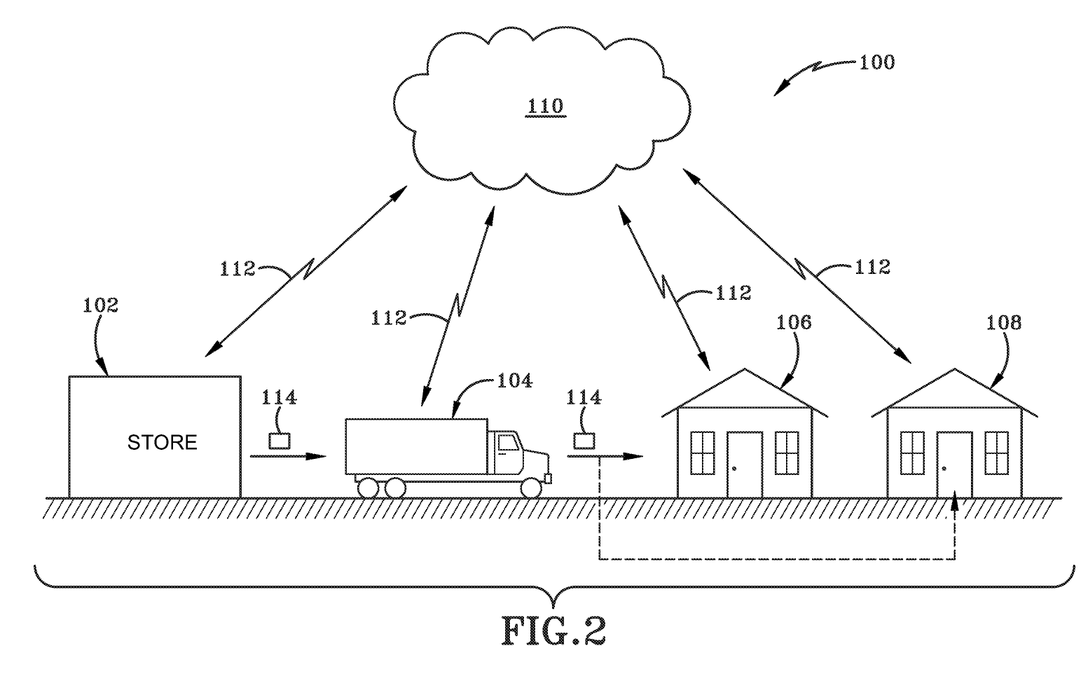

The personalized on-demand package delivery system depicted in the present disclosure may be accessed via the Internet or World Wide Web implemented by computing environment 10. FIGS. 2-11 depict exemplary screenshots or diagrams of the package delivery software or system, in accordance with the present disclosure, which performs some of the methods described herein.

FIG. 2 depicts a personalized package delivery system in accordance with the present disclosure generally at 100. System 100 includes a consignor 102, a carrier 104, a consignee or customer 106, and a third-party consignee 108, which may also be referred to as a designated consignee 108. Each of the parties is respectively connected with a network 110 as indicated by links 112. As described in the background, a typical delivery process involves the carrier 104.

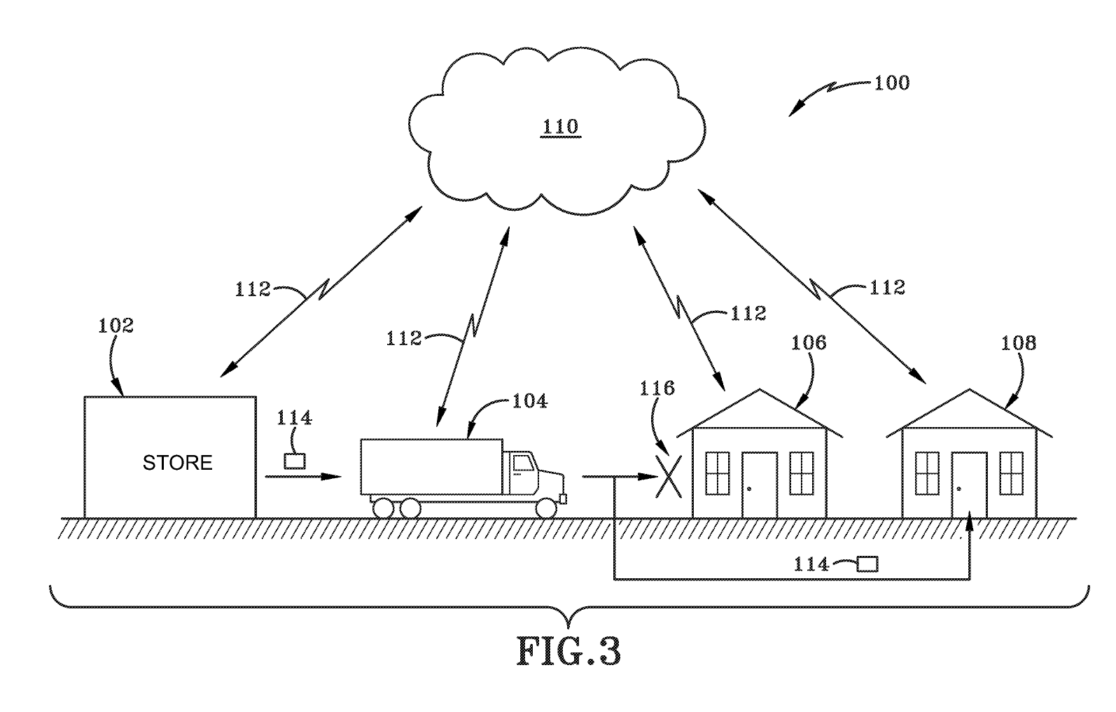

FIG. 3 depicts system 100 with the designated consignee 108 being able to receive package 114. As described in greater detail below, when the consignee 106 is unable to receive the package 114, as shown generally by the X 116, the package 114 is routed and delivered to the designated consignee 108 responsive to instructions provided by the consignee 106.

The manner in which the consignee 106 instructs the carrier 104 to deliver the package 114 to the designated consignee 108 is provided below. In accordance with one aspect of the present disclosure, the designated consignee 108 is selected from an on demand service integrated into a virtual checkout module 118 of the consignor 102, which is commonly any online retailer, such as Amazon or the like. Colloquially, the software or associated application having an Application Program Interface (API) running in the checkout module 118 is known as the “Ship Safe Neighbor.” Further, designated consignees 108 may colloquially be referred to as “Ship Safe Neighbors.”

System 100 may incentivize customers 106 to ship their package 114 to a designated consignee 108 inasmuch as using the designated consignee 108 to receive the package 114 will save time and money for the consignor 102 and the carrier during the “last mile” of delivery. Further, this should also assist in the security of package 114 to eliminate or reduce the likelihood of a “porch pirate” stealing the package from the home of customer 106.

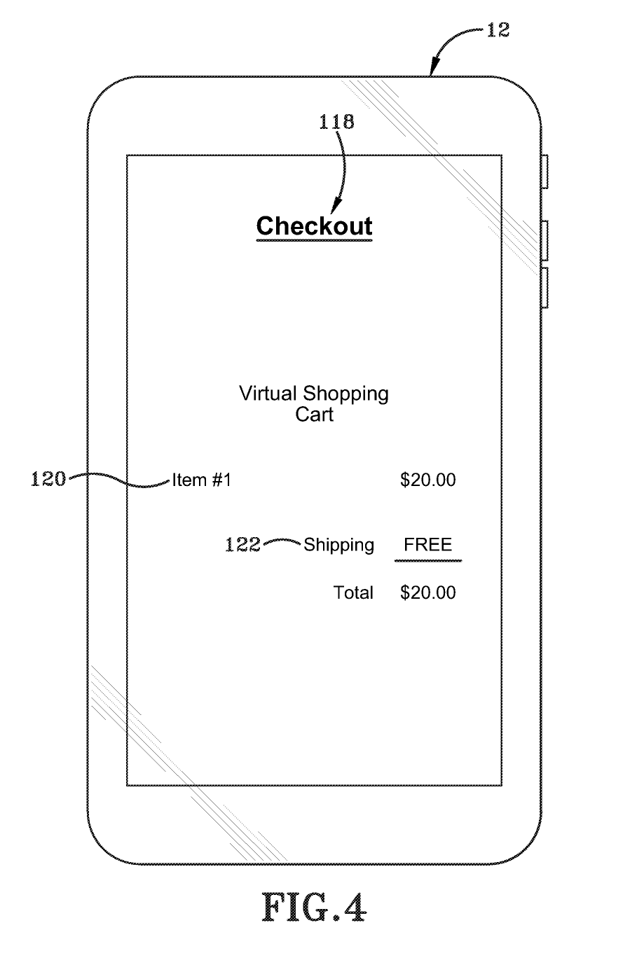

FIG. 4 depicts computer 12 in the form of a smart phone or a tablet displaying a virtual checkout module 118, which is part of an online shopping experience of the retailer or consignor 102. The checkout module 118 depicts a virtual shopping cart in which an item 120 is selected for purchase. The checkout module 118 may further include a line item for shipping costs, which is shown generally at shipping 122, and a continue button 124 to proceed with the transaction. In one particularly embodiment, the computer 12 may be operated by the consignee 106. The checkout module 118 would be owned and operated by the consignor 102 and they are in operative communication with each other through links 112 across network 110. Notably, while FIG. 4 indicates that the shipping 122 could be “FREE”, the shipping value or cost can reflect an amount that the consignor 102 or carrier 104 would determine, such as $3.99, $4.99, $5.00, or any other amount. Further, the shipping fees would include the costs associated with paying for the designated consignee service linked with the checkout module, as described in greater detail below. In instances where free shipping is offered, the consignor 102 may pay some cost to the designated consignee 108 through a third party application, even though the customer 106 is still receiving free shipping.

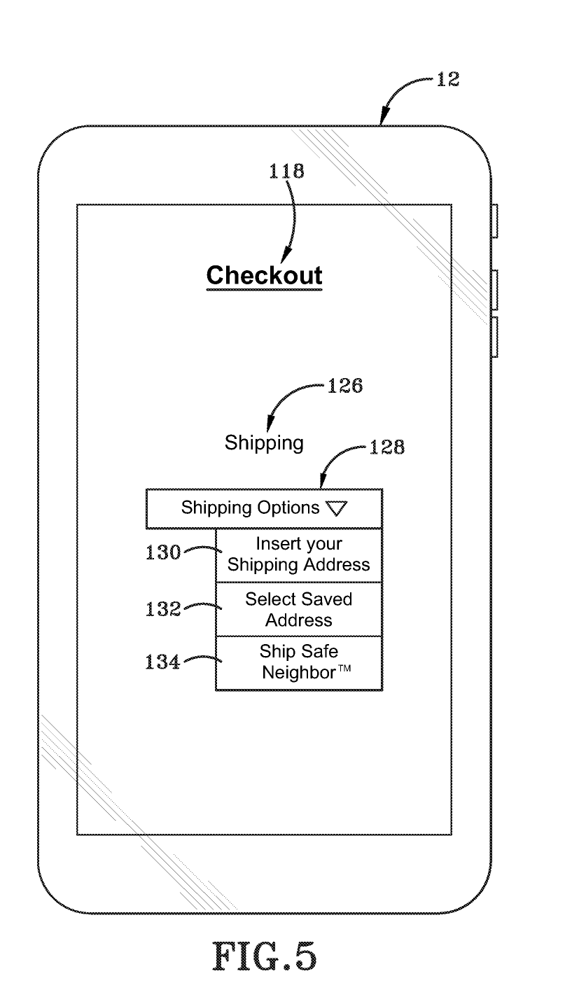

FIG. 5 depicts a shipping portal within the checkout module 118. The shipping portal 126 may include a shipping options drop down bar 128. The shipping options drop down bar 128 may include at least three categories, however other categories with fewer options are entirely possible. Particularly, the shipping options drop down bar 128 may include an option to insert a shipping address 130, select a saved address 132, or ship the package 114 of item 120 to a ship safe neighbor 134 (i.e., the designated consignee 108) in accordance with the present disclosure. The third option for a ship safe neighbor 134 is what enables the consignee 106 to designate the carrier 104 to direct the package 114 to the designated consignee 108. Notably, the first option for inserting a shipping address 130 and the second option of selecting a saved address 132, are conventionally known in online shipping portals 126, which is part of a conventional checkout process module 118. The third option of selecting a safe neighbor (i.e., the designated consignee 108) to ship to, which is shown generally at 134, to feature the present disclosure, which has heretofore been unavailable.

In accordance with one aspect of the present disclosure, the option of selecting a ship safe neighbor, which is the designated consignee 108, can help alleviate costs on the carrier 104 in the event that the consignee 106 is not able to be home when the package 114 needs to be delivered. Alternatively, the designated consignee 108, which is selected by the third option for a ship safe neighbor 134, insures that the package 114 is delivered to a safe location so its contents are not stolen or lost by leaving the package 114 with the consignee 106 when they may not be home.

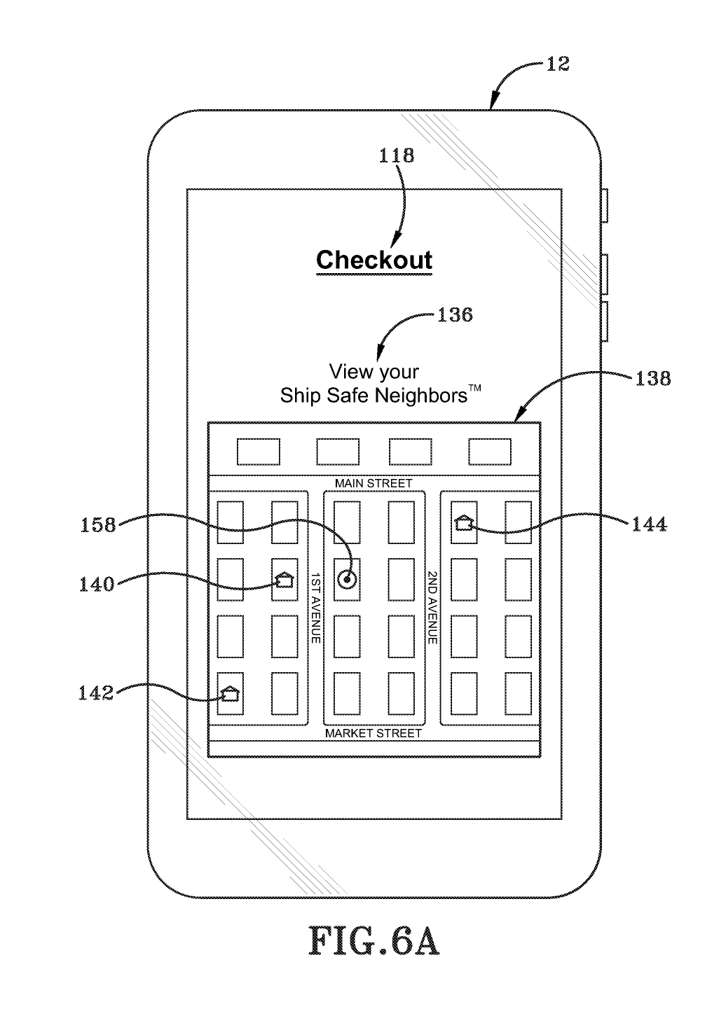

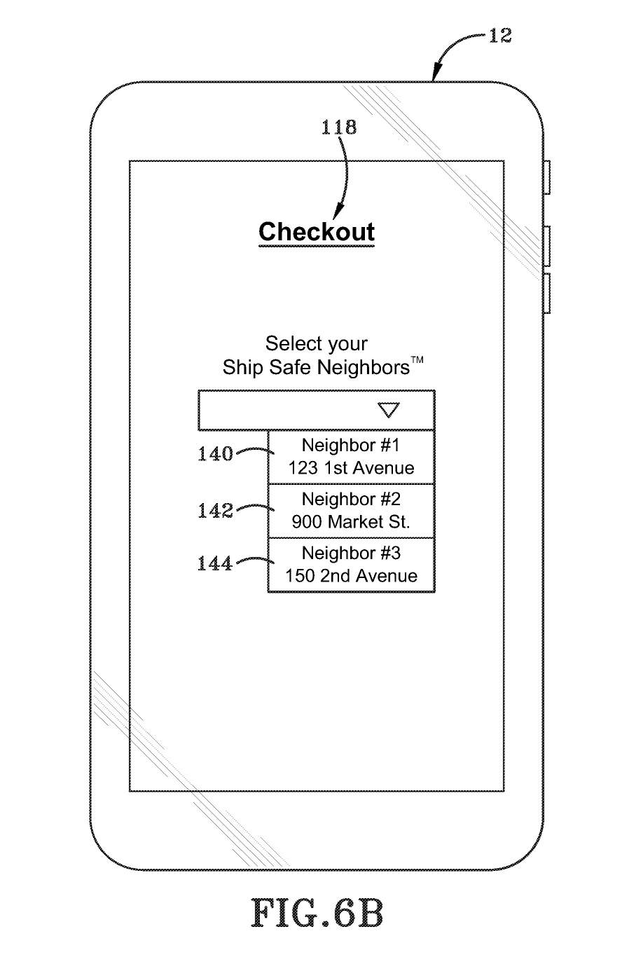

FIG. 6A depicts the checkout module 118 when the customer or consignee has selected the ship safe neighbor option 134. The checkout module enables the customer to view their ship safe neighbors at 136 and displays a map 138. Within the map 138, GPS technology may be utilized and associated with computer 12 to identify the customer's location at 140, wherein for this scenario the customer is the consignee 106. The map 138 may further include at least one designated consignee locations within the map. In this particular scenario, there may be a plurality of designated consignees 108. A first designated consignee 140, a second designated consignee 142, and a third consignee 144 are within a general vicinity of the consignee's location 140 on map 138. The manner in which the designated consignee 108 is populated and displayed on map 138 is described in greater detail below.

Alternatively, FIG. 6B depicts the checkout module 118 when the customer or consignee has selected the ship safe neighbor option 134. The checkout module enables the customer to view their ship safe neighbors at 136 in a list format. Within the list format, GPS technology may be utilized and associated with computer 12 to identify the customer's location at 140, wherein for this scenario the customer is the consignee 106. The list may further include at least one designated consignee locations within the map. In this particular scenario, there may be a plurality of designated consignees 108. A first designated consignee 140, a second designated consignee 142, and a third consignee 144 are within a general vicinity of the consignee's location 140.

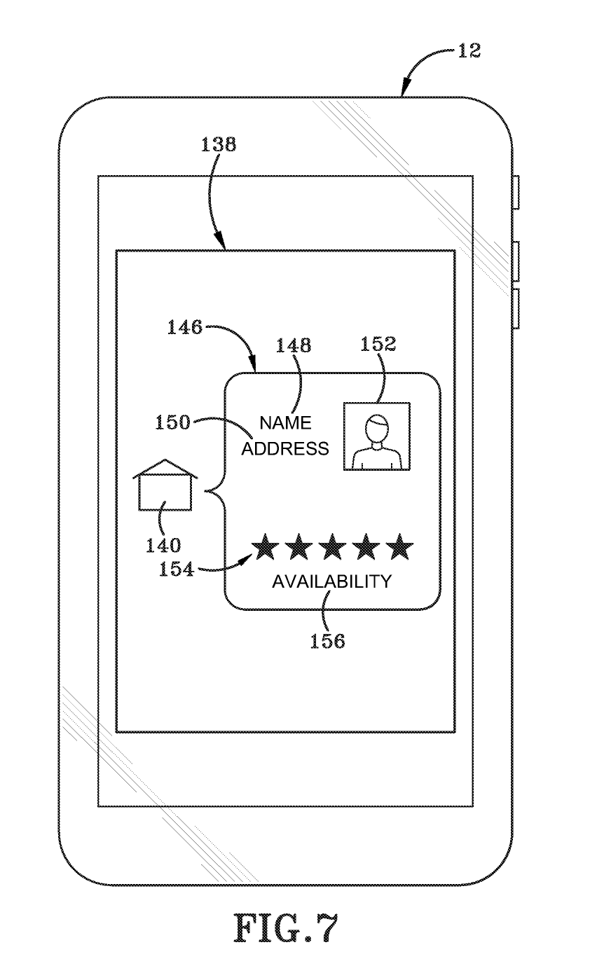

FIG. 7 depicts that the user may tap the touch screen of the computer 12 for the icon of each of the designated consignees 108. More particularly, if the user selects the first designated consignee 140, a profile indicator popup box 146 may display a profile of the first designated consignee 140 in addition to their address and a rating provided by other purchasers. The profile box 146 of the first designated consignee 140 may include a name 148, their address 150, a profile picture 152, a rating 154 as submitted by other users, and general availability hours 156 upon which the consignee 106 may pick up their package 114 from the location of the first designated consignee 140.

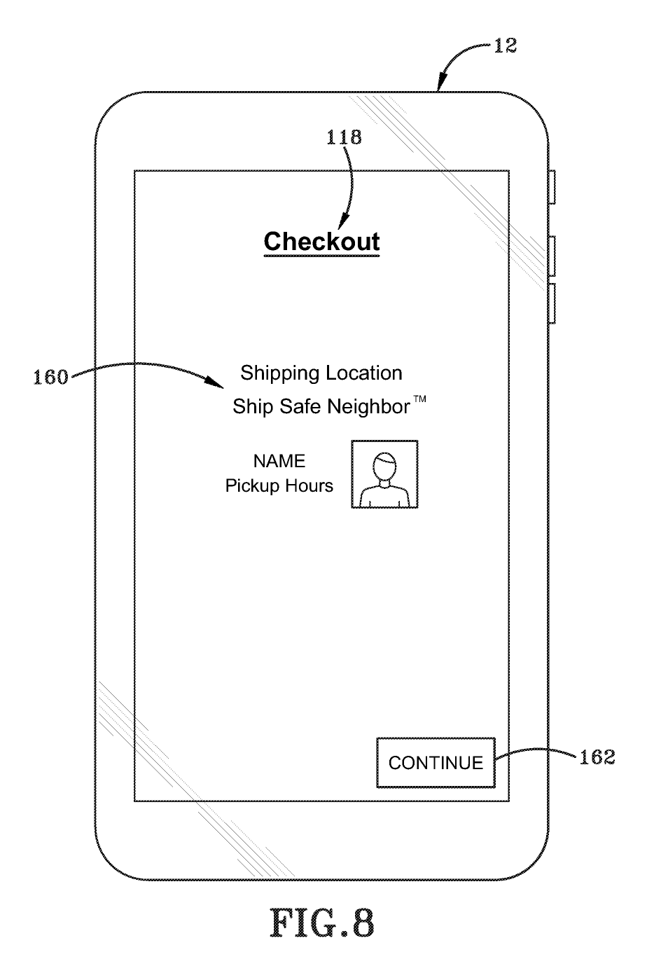

FIG. 8 depicts a portion of the checkout module 118 subsequent selecting one of designated consignees 108. Particularly, FIG. 8 depicts that the first designated consignee 140 has been selected. In the checkout module 118, the shipping location of the ship safe neighbor, and their name, and available pick up hours may be shown generally at 160. The purchaser may then continue with their purchase by clicking button 162 and proceed through a conventional payment process. Some exemplary, conventional payment processes utilize direct payments through their retailer website or through third party payers, such as PayPal, or the like.

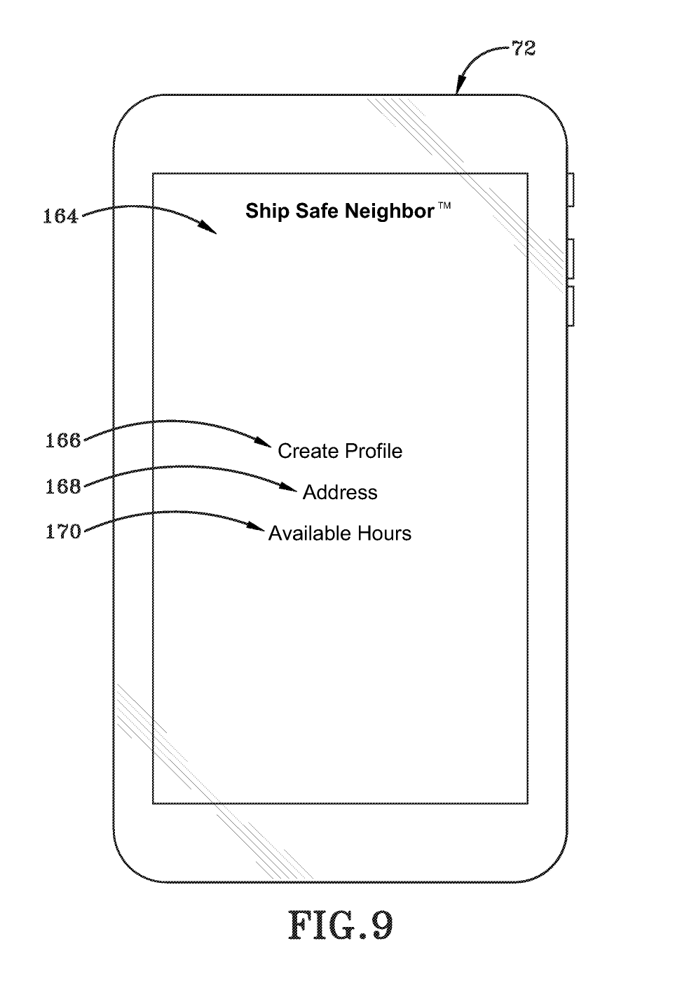

FIG. 9 through FIG. 12 depict a portion of the system 10 in which a third party individual may become (i.e., register as) a designated consignee 108. Stated otherwise, the designated consignee 108 is able to selectively choose their availability to receive incoming packages 114 on behalf of the consignee 106 on an as needed or on demand basis. A user of the remote computer 72 (i.e., a person intending to register as a designated consignee 108) will log on to a third party application or website 164 to create a profile 166 indicating their address 168, and their available pick up hours 170. The creation of the profile 166 will also enable the user to upload a picture or avatar. The creation of the profile may be accomplished during account creation upon the first time a person signs up with the third party application or website 164 to become a designated consignee 108.

The hours 170 that the user desires to work in becoming a designated consignee 108 is variable to the user's preference. In some embodiments, the user may select designated times per week that the user acts as a designated consignee 108 for pick-up of the packages 114. For example, during the creation of the profile 166, the user may indicate that consignees 106 can pick up packages 114 delivered to the designated consignee address 168 between the hours of 4:00 pm and 8:00 pm Monday, Wednesday, Friday (for example, during normal business hours). Alternatively, it is envisioned that the present disclosure includes features for on demand pick up and availability, similar to that of a ride sharing service (such as Uber or Lyft). In this scenario, the designated consignee 108 may sign on to the website 164 and initiate their availability by “going online.” Then, when the user desires to go offline and stop working, which would correspond to being unavailable to receive packages 114, or receive consignees 106 at their home to pick up the packages 114 that were previously left by the carrier 104, after the completion of the online purchase.

Clearly safety and theft is a major concern. Thus, a designated consignee 108 could be subjected to a background check prior to their registration being approved by the operator of the system 100. By performing a background check of the applicant to become a designated consignee, the operator of the system 100 should be able to reduce instances of unverified addresses and location and additionally be able to reduce instances of theft. However, in other scenarios, a background check may not be required as it could add additional costs to the system. For example, the additional costs would likely be incurred by the third party application or website 164. Accordingly, another scenario of the present disclosure could simply provide that the designated consignee 108 is required to accept the terms and conditions to establish a contractual agreement between the designated consignee and the third party application or website 164 or the consignor 102 or the carrier 104.

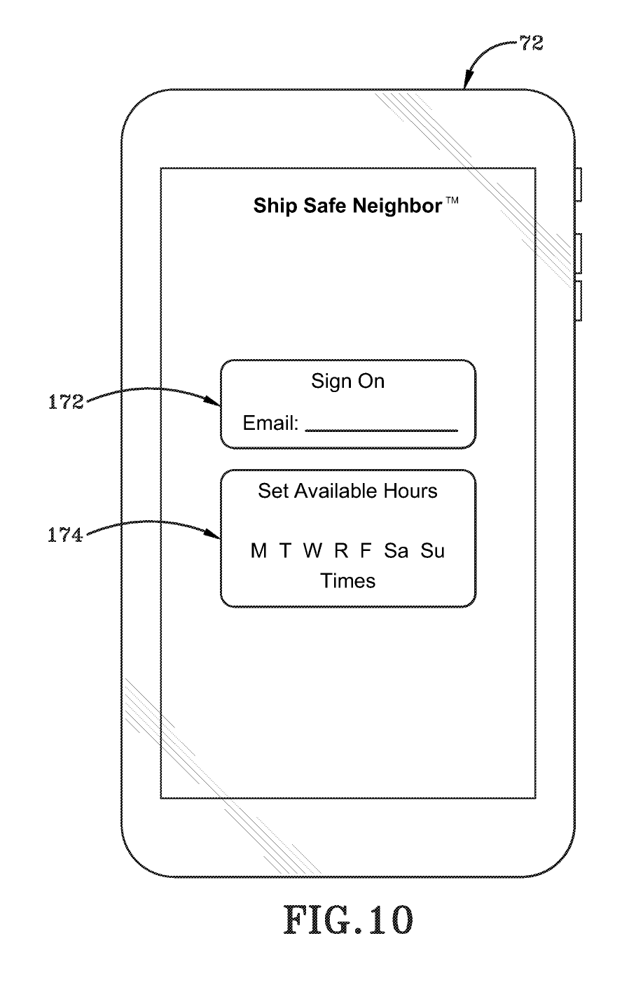

FIG. 10 depicts an exemplary profile creation in which the user of the remote computer 72 is desiring to become a designated consignee 108 particularly after logging in, generally shown at 172. The login 172 may include a username and secured password. This data may be stored on a cloud server of the third party application or website 164. The user may set their hours and available times per week or per day in which they will act as the designated consignee 108. The available hours 174 may be broken down into day formats or week formats and can be selectively customized by the designated consignee 108. In one particular embodiment, the designated consignee 108 would be required to be available for drop off during at least some daily working hours to ensure that a parcel delivery service (i.e. the carrier 104) such as FedEx or UPS, will have the ability to deliver the packages to the designated consignee 108. Alternatively, it would be possible for the designated consignee to be responsible for picking up packages directly from the carrier 104. In this scenario, to ensure liability remaining on the designated consignee 108, the contractual relationship would need to be clearly established through an agreement of the terms and conditions of the third party application or website 164. It is envisioned that becoming a designated consignee 108 will be a functional and efficient manner in which a person who typically remains home during the day can earn extra money to receive packages 114 on behalf of the consignee 106. Payment terms and salaries or percentages of shipping costs to be paid to the designated consignee 108 can be varied in a number of different ways. For example, the carrier 104 may pay the designated consignee 108 a small percentage of the shipping costs inasmuch as the designated consignee 108 is guaranteeing their presence at their home so as to eliminate, or substantially reduce, the costs associated with the carrier 104 during the “last mile” of delivery.

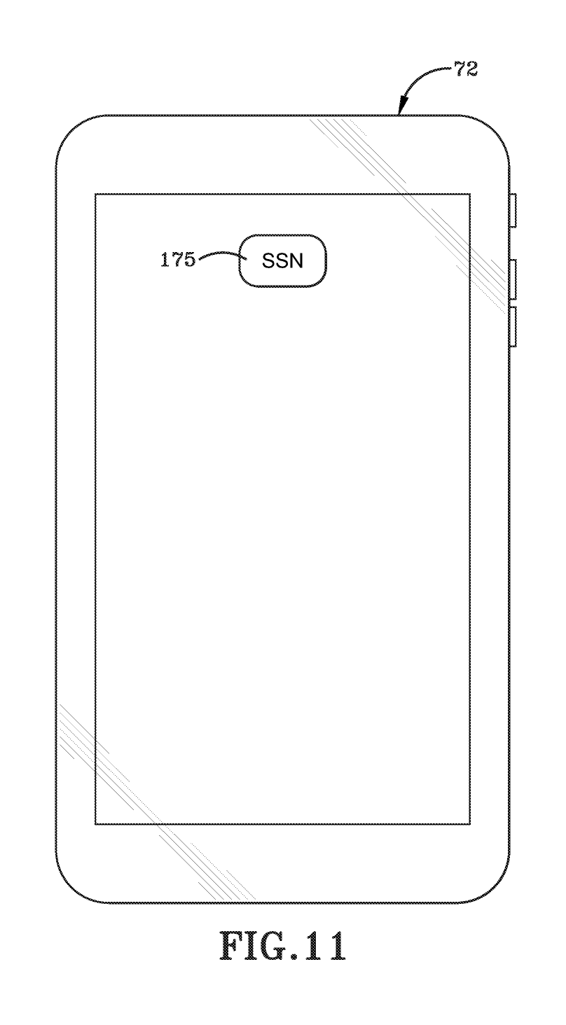

FIG. 11 depicts that a mobile application may be downloaded and installed on the computer 72. When downloaded, the application may display an icon 175 located on the homescreen of the computer. The computer 72, having a touchscreen, will display the icon 175 that may launch the application or website 164 upon tapping the icon 175 on the touchscreen.

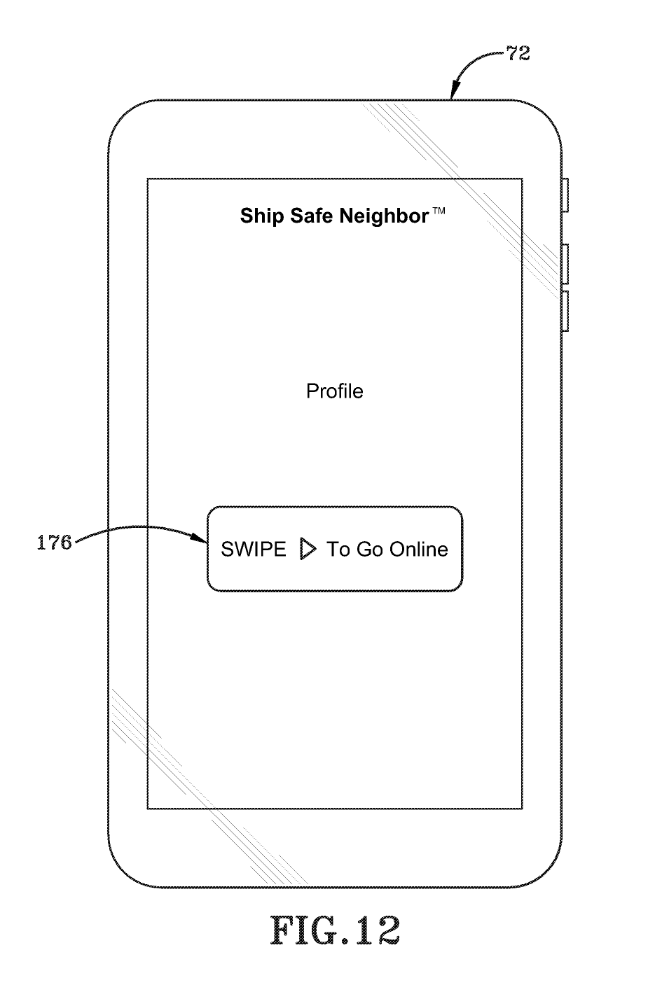

FIG. 12 depicts the scenario of the designated consignee 108 using the remote computer 72 on demand, or as needed basis, similar to that of popular ride sharing services. Once the user creates a profile, the App or website may include a swipe bar 176 or other access item, which would enable the designated consignee 108 to go “live,” which would populate their icon into map 138. The designated consignee 108 will have identified which days they are available for receiving persons at their location. The carrier 104 will not have to establish a route based on the designated consignee 108 availability. The flexibility of an on demand service enables the designated consignee 108 to selectively choose when they want to work or otherwise be available to receive the packages 114 either from the carrier 104 or to receive consignees 106 at their home. Payment terms and other money earning arrangements for person acting as the designated consignee 108 may be structured similar to those offered by popular ride sharing programs. Some exemplary payment or money earning arrangements may include, PayPal, Venmo, Bitcoin, or other money payment applications taking advantage of online fund transfer or block chain technology. Additionally, designating themselves as available online on an on demand, or as needed basis, similar to ride sharing Apps, enables the designated consignee 108 to have an icon populated in the user interface during the online checkout module 118 during the consignee's online shopping experience.

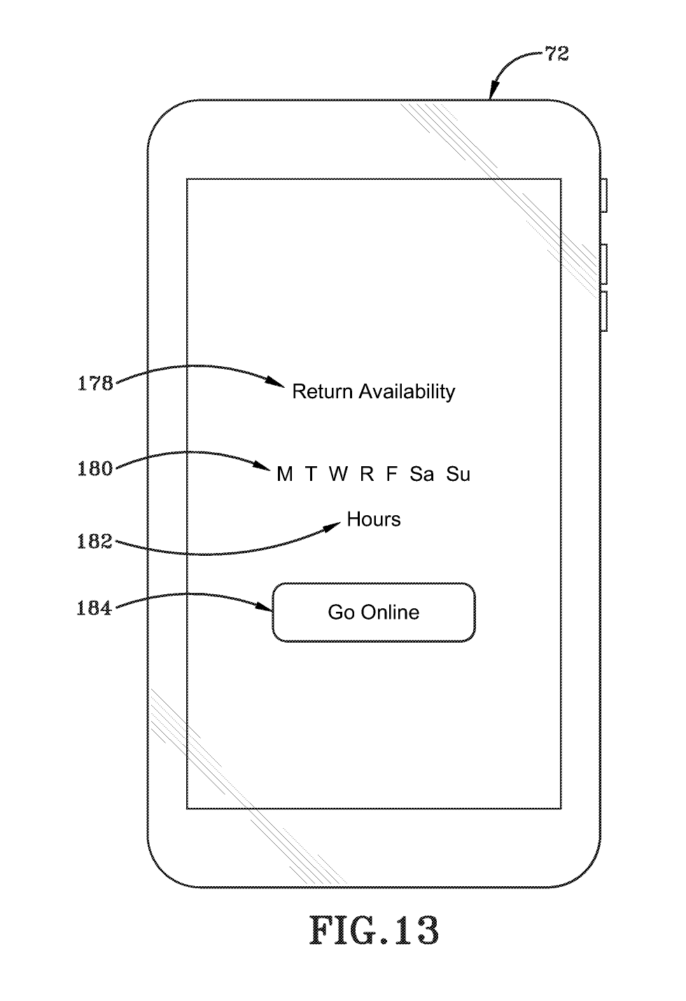

FIG. 13 depicts an optional alternative scenario for the designated consignee 108 in which they can indicate that they are available for returns. The selection of returning items at 178 can include a profile to determine which days of the week 180, and what hours 182, the carrier 104 can pick up items that had been dropped off by a consignee 108 (which, in this case, would be acting as a consignor needing to ship package 114 back to the original consignor 102, which in this scenario, acts as a consignee to accept a return). When the designated consignee 108 goes online by activating button 184, the availability may also indicate to the original consignee 106 what days and times the designated consignee 108 is available to accept and receive packages 114 that need to be returned to the original sender (i.e., consignor 102). However, as this optional, the designated consignee 108 is able to indicate that they do not desire to be a return shipping location.

Furthermore, designated consignee 108 can further act as a shipping agent for packages 114 being sent to other locations, beyond simply returning a package to the original consignor. For example, the designated consignee 108 can act as a drop off location for an individual to send a package to any recipient. The designated consignee 108 will make their available hours known for which items may be dropped off at their home and a carrier 104 will pick them up for shipment.

As depicted throughout the figures herein, and in accordance with one aspect of the present disclosure, the system 100 generally enables a purchaser of an online item to selectively designate a designated consignee to receive a package 114 in the event that the original consignee 106 knows they will not be home and want to leave the package 114 at a same location. System 100 further provides a manner for a person who ordinarily stays home (such as a “stay at home mom” or a person who works from home) to earn extra money or to have other incentives to allow carrier 104 to drop off multiple packages 114 for other individuals in the neighborhood as their home.

In operation and with reference to FIG. 4 through FIG. 8, an exemplary method or process of operation enables the consignor 102 to provide an online shopping experience for the consignee or customer 106. Some exemplary aspects of the method include providing, by the consignor 102, a virtual storefront that sells items to be purchased by at least one customer 106. The method may further include providing the virtual checkout module 118 to allow the at least one customer 106 to purchase items from the virtual storefront to complete a commercial transaction. The method may further include effecting, during a virtual checkout process in the virtual checkout module 118, the at least one customer 106 to select a shipping address of the designated consignee 108 that is different from a home or work address of the at least one customer 106. In one exemplary embodiment, the designated consignee 180 is a residential neighbor of the at least one customer. This exemplary method may further include packaging the purchased items or effecting the purchased items to be packaged into a parcel or package. The method further includes effecting the carrier 104 to ship the purchased items of the at least one customer to the designated consignee. The method may additionally include effecting the at least one customer 106 to retrieve the purchased items from the designated consignee 108.

In this exemplary embodiment or another exemplary embodiment the method relating to the consignor 102 sending the purchased items to the designated consignee 108, the method may further include providing a selection menu during the virtual checkout process in the virtual checkout module 118 to the at least one customer 106, wherein the selection menu identified one or more designated consignees that have previously agreed, by way of a shipping agreement entered into by the consignor 102 associated with the virtual storefront and the designated consignee 108, to receive the purchased items on behalf of the at least one customer. For example, the computer or tablet, or smartphone, which may be collectively referred to as a an access terminal of the customer 106 having the virtual checkout module displayed thereon can display, as shown in FIG. 6 by way of a map, the first designated consignee 140, the second designated consignee 142, and the third designated consignee 144 who have all agreed to become a ship safe neighbor (i.e. a designated consignee). The Agreement entered into between the designated consignees and the consignor 102 may be effectuated by the third party application running the website 164 or the third party application. The third party application or website 164 will effectuate, through its terms and conditions, the mutual agreement between the consignor 102 and the designated consignee 108. However, it is entirely possible that the relationship be a direct relationship established between the consignor 102 and the designated consignee 108.

In this exemplary embodiment or another exemplary embodiment the method relating to the consignor 102 sending the purchased items to the designated consignee 108, the method may further include displaying one or more of the designated consignees (i.e., such as first consignee 140, second designated consignee 142, and third designated consignee 144) during the virtual checkout process in the virtual checkout module in response to the designated consignees 108 signing on to a third party application or website 164 via a computer terminal (such as another terminal 72) and making themselves available to receive the purchased items on behalf of the at least one customer 106. For example, the third party application or website 164 has the features of enabling the designated consignee 108 to go online (such as through a swipe bar 176 or a button or icon 184). The ability to make themselves available, as shown in FIG. 11 and FIG. 12, enables the designated consignee 108 receive the purchased items on behalf of the at least one customer 106.

In this exemplary embodiment or another exemplary embodiment the method relating to the consignor 102 sending the purchased items to the designated consignee 108, the method may further include effecting the at least one customer to select one of the displayed designated consignees prior to completing the commercial transaction. For example, as shown in FIG. 6-FIG. 8, the customer 106 is able to select one of the designated consignee's, such as the first designated consignee 140, and displays profile regarding the same, identified by profile 146, and is able to complete the virtual check out process by tapping the continue button 162 to ensure that the consignor 102 instructs the carrier 104 to ship its purchased items through a package or parcel to the designated consignee 108, which in this example is the first designated consignee 140. With continued reference to FIG. 6-FIG. 8, the selection of the first designated consignee 140 is completed prior to completing the commercial transaction in the virtual checkout process.

In this exemplary embodiment or another exemplary embodiment the method relating to the consignor 102 sending the purchased items to the designated consignee 108, the method may further include effecting the at least one customer to select a preferred designated consignee prior to completing the commercial transaction; effecting the preferred designated consigned to confirm its availability to receive the purchased items; and identifying to the least one customer that the preferred designated consignees is available to receive the purchased items subsequent to completing the commercial transaction and prior to delivering the purchased items to the preferred designated consignee. For example, when the virtual checkout module 118 is displaying a plurality of designated consignee's 108, one of the designated consignee's 108 may be a preferred designated consignee. In this example, the preferred designated consignee may be the first designated consignee 140. The manner in which deems the first designated consignee 140 as the preferred designated consignee may be based on a number of factors. One exemplary factory may be the location of the first designated consignee 140 relative to the location 150 of the customer. However, other factors may be utilized to determine the preference or preferential nature of establishing one designated consignee 108 as a preferred designated consignee. Another factor may be the rating 154 as submitted by other users of the third party application or website 164.

Preference of the preferred designated consignee may be given a higher weight so as to rank the preferred designated consignee, such as the first designated consignee 140, in a higher display hierarchy that allows the customer 106 to select the preferred designated consignee more frequently. Stated otherwise, by having a preferred designated consignee ranked higher on a list, the preferred designated consignee is more likely to be selected by a customer completing the virtual checkout process on the virtual checkout module 118.

In this exemplary embodiment or another exemplary embodiment the method relating to the consignor 102 sending the purchased items to the designated consignee 108, the method may further include displaying one or more of the designated consignees during the virtual checkout process in the virtual checkout module 118 in response to the designated consignees identifying their availability through a third party application or website 164 via a remote computer terminal 72 and making themselves available to receive the purchased items on behalf of the at least one customer. For example, as depicted in FIG. 9-FIG. 12, a user of the third party application or website 164 displayed on a remote terminal 76 is able to identify their hours 174 and can go online as to indicate that they are available and willing to accept packages from the carrier 104 on behalf of the customer 106. Typically, with respect to the availability hours 174, the times would correspond to a time frame when a person is not home to receive a package. For example, if a purchased item requires a signature by someone over the age of 18 years old, then the designated consignee 108 should choose hours during the day that would effectuate the receipt of the package or parcel on behalf of the customer 106 and would be congruent with the route timing of the carrier 104, such as normal business hours. Further, it may be advantageous for the designated consignee 104 to further select available hours 174 in which the customer 106 may retrieve or pick up their purchased items in its package or parcel from the location of the designated consignee 108.

In this exemplary embodiment or another exemplary embodiment the method relating to the consignor 102 sending the purchased items to the designated consignee 108, the method may further include displaying one or more of the designated consignees during the virtual checkout process in the virtual checkout module in response to the designated consignees identifying their availability through a consignor hosting the virtual storefront via a computer terminal accessing a terminal of the organization and making themselves available to receive the purchased items on behalf of the at least one customer. For example, displaying the designated consignees 108 may be accomplished through the map 138 only when or in response to designated consignees 108 identifying via their profile and availability hours 174 as set up via the third party application or website 164 on the remote computer terminal 72. Third party application or website 164 cooperates with the checkout module 118 operating on the customer computer 12.

In this exemplary embodiment or another exemplary embodiment the method relating to the consignor 102 sending the purchased items to the designated consignee 108, the method may further include activating a designated consignee option, via designated consignee control logic hosted by the consignor, during the checkout process by the at least one customer; accumulating a plurality of orders from different customers, by the consignor, that have each selected their respective purchased items to be sent to the same designated consignee; effecting a carrier to delivered the purchased items from the different customers that have been accumulated to be delivered to the designated consignee. For example, when the customer 106 is completing the virtual checkout process in the virtual checkout module 118 on the customer computer 12, they may activate the designated consignee option 134 by selecting the same from a drop down menu 128 (FIG. 5). The option 134 for the designated consignee may be designated by consignee control logic hosting by the consignor 102 that effectuates the display of the virtual check out module 118 for the different customers 106 to select a designated consignee 134. In some implementations, consignor 102, which is operating the virtual storefront, may accumulate a plurality of orders from different customers who are all intending to send their purchased items to the same designated consignee, such as the first designated consignee 140. By aggregating or otherwise accumulating the orders, this may reduce overall order fulfillment, however as one having skill in the art would understand it is not required to complete the delivery of the purchased items to the designated consignee 108.

In this exemplary embodiment or another exemplary embodiment the method relating to the consignor 102 sending the purchased items to the designated consignee 108, the method may further include allotting, by the consignor, the designated consignee an allotment of purchased items that are packaged independently to different customers to be delivered to the designated consignee. For example, since the plurality of customers will be individual and distinct persons all ordering different items, the allotment provided by the consignor 102 to the designated consignee 108, such as the first designated consignee 140 (FIG. 6) shall include a plurality of independently packaged items that collectively define the allotment that the carrier 104 may deliver in a single delivery to the designated consignee.

In this exemplary embodiment or another exemplary embodiment the method relating to the consignor 102 sending the purchased items to the designated consignee 108, the method may further include alerting, by the consignor, the customer that has selected the designated consignee subsequent to completing the virtual checkout process; alerting, by the consignor, the customer that the carrier has delivered the purchased items of the customer. Further, the method may provide alerting the customer that the carrier has delivered the purchased items of the customer occurs subsequent and in response to the consignor receiving a notification from the carrier that the purchased items were delivered to the designated consignee. For example, different alerts may be sent to the customer computer 12 via alert logic hosted by the consignor 102 on its servers that is configured to alert the customer 106 that its purchased items from the virtual storefront have been packaged, are in transit, or have been delivered to the designated consignee 108. In some implementations, the alert may come in the form of a text message, and in other implementations the alert may come in the form of an email. Typically, the alerts are generated in response to the consignor, such as Amazon, receiving an alert from the carrier that the package has begun movement in its shipment process. Thus, the alert is responsive to a carrier's notification that the package is in the shipment process. However, it is entirely possible that the alert be generated by the carrier 104 and sent directly to the customer computer 12 and therefore bypass the consignor 102.

In this exemplary embodiment or another exemplary embodiment the method relating to the consignor 102 sending the purchased items to the designated consignee 108, the method may further include appending, by the consignor, at least a portion of a profile having an independent rating of the designated consignee generated from reviews of other customers to the customer in a confirmation email or receipt subsequent to completing the virtual checkout process. For example, the rating 154 that is shown during the checkout module 118 on the customer computer 12 may further be appended to confirmation receipt or confirmation email that the consignor 102 provides to the customer 106 in response to completion of the virtual checkout process. This may prove beneficial in some instances where a user may forget the rating of the designated consignee 108 so they may easily reference the same in the emailed receipt.

In this exemplary embodiment or another exemplary embodiment the method relating to the consignor 102 sending the purchased items to the designated consignee 108, the method may further include assigning, by the consignor, a reliability index of the designated consignee to the carrier prior to delivery of the purchased items of the customer, wherein the reliability index is adapted to provide the carrier or the customer a reliability rating of the designated consignee that the designated consignee will successfully transfer the purchased items to the customer; and prohibiting future customers from selecting the designated consignee during the virtual checkout process if the reliability index falls below a pre-selected threshold as set by the consignor. Additionally, the method may provide billing the customer, by the consignor, for shipping services of the carrier to deliver the purchased items to the designated consignee. In another example, a billing amount varies in response to the reliability index, wherein the billing amount for a designated consignee with a higher reliability index is greater than the billing amount for another designated consignee with a lower reliability index. The method may also provide bypassing, by the consignor, the display of a designated consignee in a customer access terminal during the virtual checkout process when the reliability index falls below the pre-selected threshold. For example, the consignor may store a reliability index operative through various algorithms, processes, or other logic that can utilize the rating 154 in conjunction with other factors, such as the number of available hours, and other useful features such as access to common roadways to generate the reliability index. Further, the reliability index may be variable in response to a number of packages of purchased items being picked up over time that generate rating 154 from other customers using the designated consignee 108. Then, if the algorithm, process, or logic operated by either the consignor or in other implementations the third party application or website 164 determines that the reliability or rating index falls below a certain threshold, the system may prohibit or otherwise reduce the ability of the designated consignee to act as a designated consignee for customers 106. In some instances, during the checkout process, the cost for shipping 122 may be varied in response to the reliability of the designated consignee. For example, if the system determines that the reliability index of the designated consignee 108 is sufficiently high and above the threshold, then the checkout module 118 may offer free shipping. However, if the system is able to use the reliability index to determine the likelihood that the designated consignee 108 will cause difficulty for the carrier to deliver the purchased items, then the shipping cost 122 may be increased for that designated consignee 108. This should incentivize the designated consignees 108 to have great flexibility in providing their availability for customers 106 to pick up the items and encourage the designated consignee 108 to cooperate and safely deliver the purchased items received by the carrier at their home to the customer 106.

In this exemplary embodiment or another exemplary embodiment the method relating to the consignor 102 sending the purchased items to the designated consignee 108, the method may further include channeling customers to a plurality of designated consignees during the checkout process in response to a location determination performed at a customer terminal, wherein the customers are channeled to the plurality of designated consignees that are in closest proximity to the customer as determined by the location determination. For example, the checkout module 118 may prioritize or otherwise channel the customer to select a designated consignee, such as the first designated consignee 140 that is in the closet location or nearest proximity to the location 158 of the customer 106. In some instances, rather than the map 138, the designated consignees 108 are provided in a list format, wherein the list format is sorted to have the nearest designated consignee, such as the first designated consignee 140, to be at the top of the list.

In this exemplary embodiment or another exemplary embodiment the method relating to the consignor sending the purchased items to the designated consignee 108, the method may further include determining, by the consignor, a nearest available designated consignee in response to the customer selecting a shipping preference to the designated consignee during the virtual checkout process; and displaying a plurality of designated consignees to the customer prior to completing the virtual checkout process, wherein displaying the plurality of designated consignees may be accomplished through one of a list format and a map format.

In this exemplary embodiment or another exemplary embodiment the method relating to the consignor 102 sending the purchased items to the designated consignee 108, the method may further include comparing, by the consignor, a request by the customer to deliver the purchased package to the designated consignee with a pre-selected availability of the designated input into a third party application cooperating within the virtual checkout module of the consignor; and enabling the customer to select the designated consignee when the pre-selected availability of the designated consignee matches the request by the customer and preventing the customer from selecting the designated consignee when the pre-selected availability of the designated consignee does not match the request by the customer. For example, availability 156 of the designated consignee, as displayed in the customer computer 12 should match the timeframe at which the customer 106 desires to pick up their package or parcel.

In this exemplary embodiment or another exemplary embodiment the method relating to the consignor 102 sending the purchased items to the designated consignee 108, the method may further include transferring, from the consignor, a data packet containing location information of the designated consignee and shipping information for the packaged items to the carrier, wherein the data packet is transferred prior to the carrier shipping the package; and effecting the carrier to confirm that the purchased items are to be delivered to the designated consignee and later retrieved by the customer. However, it is possible for the data packet to be transferred simultaneously or in real time as the carrier 104 ships the package of purchased items to the designated consignee 108. The manner in which the carrier 104 can confirm that the purchased items were delivered to the designated consignee and later retrieved by the customer may be accomplished by requiring the designated consignee to upload or confirm through the third party application or website 164 that the purchased items were retrieved by the customer 106. The third party application or website 164 may then broadcast or otherwise transfer this information through additional data packets to the carrier 104 or the consignor 102.

In this exemplary embodiment or another exemplary embodiment the method relating to the consignor 102 sending the purchased items to the designated consignee 108, the method may further include detecting, by the consignor in a consignor server, an execution call generated by the customer 106 from a terminal computer 12 during the virtual checkout process that the customer desires the purchased items to shipped to the designated consignee and not a home, work, or relative's address of the customer.

In this exemplary embodiment or another exemplary embodiment the method relating to the consignor 102 sending the purchased items to the designated consignee 108, the method may further include encrypting, by the consignor, pre-selected information about the designated consignee and preventing the customer from receiving or viewing the encrypted pre-selected information during the virtual checkout process. However, encryption is not required. Rather, in some instances it may be possible for some pre-selected information about the designated consignee 108, such as the first designated consignee 140, to be sent to the customer 106 before, during, or after the virtual process.

In this exemplary embodiment or another exemplary embodiment the method relating to the consignor 102 sending the purchased items to the designated consignee 108, the method may further include maintaining the encryption of the pre-selected information and preventing the customer from receiving or viewing the encrypted pre-selected information after completion of the virtual checkout process.

In this exemplary embodiment or another exemplary embodiment the method relating to the consignor 102 sending the purchased items to the designated consignee 108, the method may further include receiving shipping information of the purchased items along a route of the carrier relative to the designated consignee; and providing route information of the purchased items being shipped by the carrier to the customer including the location of the purchased items relative to the designated consignee and not a location of the customer.

In this exemplary embodiment or another exemplary embodiment the method relating to the consignor 102 sending the purchased items to the designated consignee 108, the method may further include featuring one designated consignee as a preferred designated consignee during the checkout process in response to the one designated consignee subscribing to service in a third party application having an application program interface (API) cooperating with the virtual checkout module of the consignor. For example, the third party application or website 164 may be a subscription based model in which the designated consignees 108 subscribe to a service to be able to earn money for being a designated consignee and receive packages on behalf of the customers 106. In these instances it may be possible for the subscribing designated consignees to be selected as one of the preferred designated consignees. Alternatively, the algorithm that establishes the reliability rating index may give more weight for a designated consignee that subscribes to a service within the third party application or website 164 as opposed to a free user of the third party application or website 164.

In this exemplary embodiment or another exemplary embodiment the method relating to the consignor 102 sending the purchased items to the designated consignee 108, the method may further include hyperlinking, by the consignor, a profile of the designating consignee displayed in a customer terminal during the virtual checkout process with a profile of the designated consignee maintained on a remote third party application or server.

In this exemplary embodiment or another exemplary embodiment the method relating to the consignor 102 sending the purchased items to the designated consignee 108, the method may further include instructing the carrier to deliver the purchased items to the designated consignee who was designated by the customer during the virtual checkout process.

In this exemplary embodiment or another exemplary embodiment the method relating to the consignor 102 sending the purchased items to the designated consignee 108, the method may further include paying the designated consignee to receive the purchased items on behalf of the customer. In this instance, the designated consignee may be paid by, at least indirectly, the consignor. In some instances, funding the payment to the designated consignee is accomplished by, at least indirectly, the customer who provides funding to the consignor which then pays the designated consignee. For example, some of the cost of the shipping 122 may be directed from the checkout module 118 through the third party application or website 164 into an account of the designated consignee 108 receiving the purchased items on behalf of the customer 106. Alternatively, even if the customer 106 receives free shipping, it is still possible for funding or other payments to be sent from the checkout module 118 to the designated consignee 108. One exemplary and non-limiting rationale for providing payment to the designated consignee 108 while simultaneously providing free shipping 122 to the customer 106, is that the consignor 102 will still save an overall amount of money to ensure that the packages for the purchased items are not returned as undeliverable.

In this exemplary embodiment or another exemplary embodiment the method relating to the consignor 102 sending the purchased items to the designated consignee 108, the method may further include interfacing, in the virtual checkout module, a map or list of designated consignees with a database of designated consignees hosted or stored on a remote server of a third party application.

In this exemplary embodiment or another exemplary embodiment the method relating to the consignor 102 sending the purchased items to the designated consignee 108, the method may further include locating a nearest designated consignee during the virtual checkout process in response to a customer selection to ship the purchased items to the designated consignee and not ship the purchased items to a home address, work address, or a friend or relative's home address.

In this exemplary embodiment or another exemplary embodiment the method relating to the consignor 102 sending the purchased items to the designated consignee 108, the method may further include optimizing a display in a customer terminal used to complete the virtual checkout process of the nearest designated consignee based on closest distance and ratings of the designated consignee provided by other customers.

In this exemplary embodiment or another exemplary embodiment the method relating to the consignor 102 sending the purchased items to the designated consignee 108, the method may further include offering a discount to the customer during the virtual checkout process to ship the purchased items to the designated consignee that is identified as available through a remote third party application cooperating with the virtual checkout module of the consignor; and discounting a prices of the transaction in response to the customer accepting the offer. For example, as described above, the checkout module 118 may incentivize the customer 106 to utilize the designated consignee 108 by selecting the option 134 from the drop down menu 128. Incentivizing the customer 106 may be in the form of a discounted shipping or free shipping 122. However, as explained previously, the discount may end up saving the consignor 102 money over time by not requiring the carrier 104 to return purchased products as undeliverable.

In this exemplary embodiment or another exemplary embodiment the method relating to the consignor 102 sending the purchased items to the designated consignee 108, the method may further include predefining, by the consignor, items for sale that are able to be shipped to the designated consignee, wherein the predefinition is performed prior to offering the items for sale. For example, the consignor 102 may sell a plurality of different items ranging in sizes and prices. For example, it may be beneficial in some scenarios to preclude a very expensive or very large item from being shipped to a designated consignee. Thus, the checkout module 118 can be coded with logic to determine the item that the customer 106 intends to purchase. Then, the logic may determine whether the item should have the ability for the option 134 to be selected to utilize a designated consignee 108 during the virtual checkout process. Typically, predefining the ability to take advantage of a designated consignee 108 would be performed by the consignor 102 prior to offering the items for sale via its virtual storefront.

In this exemplary embodiment or another exemplary embodiment the method relating to the consignor 102 sending the purchased items to the designated consignee 108, the method may further include proposing a preferred designated consignee to the customer during the virtual checkout process based, at least in part, on a rating and a location of the preferred designated consignee relative to a location of the customer.

In this exemplary embodiment or another exemplary embodiment the method relating to the consignor 102 sending the purchased items to the designated consignee 108, the method may further include rating, by the consignor, the designated consignee after carrier delivers the purchased items to the designated consignee and storing the rating for future analytics. For example, future analytics may take advantage of artificial intelligence or other predictive software that utilizes past results and ratings from past transactions and stores the same to create or generate a predictive outcome of a future delivery. For example, if a carrier is unable to complete a delivery to the first designated consignee 140 at a time period that was previously specified that the designated consignee 140 would be available, then the carrier 104 may submit this information to either the consignor 102 or the third party application or website 164, which may use this information to predict and modify that the availability of the first designated consignee 140 has changed. The system may take advantage of predictive algorithms that utilizes past performance or past inability to perform to model and map a more likely scenario of availability for the designated consignee.

In accordance with one aspect of the present disclosure, the system provided herein helps eliminate or reduce the likelihood that porch pirate will steal a package from the customer. Particularly, because the customer has utilized the ship safe neighbor and had the parcel directed to the ship safe neighbor, it eliminates the opportunity of a porch pirate from stealing a parcel or delivered package off the front porch of the customer. By the customer selecting a ship safe neighbor and directing the package to a safe home, the customer has the secure belief that their online packages or other parcels will be maintained by their ship safe neighbor until they are able to arrive and pick up the package.

An additional embodiment, in accordance with one aspect of the present disclosure, a method or process is provided that circumvents and reduces the likelihood that a parcel or online delivery package will be stolen by a “porch pirate” by enabling a customer to designate a consignee at a location remote from their home address, wherein the designated consignee is another individual in their neighborhood who is willing to accept the online parcel package on behalf of the customer. The system sets up a virtual handshake between the customer and the designated consignee to ensure that both parties are in agreement that the customer's package will be delivered to the designated consignee by the delivery service. Further, the delivery service carrier receives a notice that the customer has designated the designated consignee at the location to which to drop off their package. A virtual handshake may be initiated between the carrier, the designated consignee, and the customer. Thus, three participants to the equation cooperate to ensure that porch pirates are not able, or at least the likelihood is greatly reduced, that the customer's package will be delivered to its intended recipient (i.e. the customer).

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones, such as computer 12 or 72, may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “this exemplary embodiment,” “one exemplary embodiment,” “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method comprising:
providing, by a consignor, a virtual storefront that sells items to be purchased by at least one customer;
providing a virtual checkout module to allow the at least one customer to purchase items from the virtual storefront to complete a commercial transaction;
effecting, during a virtual checkout process in the virtual checkout module, the at least one customer to select a shipping address of a designated consignee that is different from a home address of the at least one customer;
packaging the purchased items or effecting the purchased items to be packaged into a parcel or package;
effecting a carrier to ship the purchased items of the at least one customer to the designated consignee; and
effecting the at least one customer to retrieve the purchased items from the designated consignee.

2. The method of claim 1, wherein the designated consignee is a residential neighbor of the at least one customer.

3. The method of claim 1, further comprising:
providing a selection menu during the virtual checkout process in the virtual checkout module to the at least one customer, wherein the selection menu identified one or more designated consignees that have previously agreed, by way of a shipping agreement entered into by an organization associated with the virtual storefront and the designated consignee, to receive the purchased items on behalf of the at least one customer.

4. The method of claim 3, further comprising:
displaying one or more of the designated consignees during the virtual checkout process in the virtual checkout module in response to the designated consignees identifying their availability through a third party application via a computer terminal and making themselves available to receive the purchased items on behalf of the at least one customer.

5. The method of claim 3, further comprising:
displaying one or more of the designated consignees during the virtual checkout process in the virtual checkout module in response to the designated consignees signing on to a third party application via a computer terminal and making themselves available to receive the purchased items on behalf of the at least one customer.

6. The method of claim 5, further comprising:
effecting the at least one customer to select one of the displayed designated consignees prior to completing the commercial transaction.

7. The method of claim 5, further comprising:
effecting the at least one customer to select a preferred designated consignee prior to completing the commercial transaction;
effecting the preferred designated consigned to confirm its availability to receive the purchased items; and
identifying to the least one customer that the preferred designated consignees is available to receive the purchased items subsequent to completing the commercial transaction and prior to delivering the purchased items to the preferred designated consignee.

8. The method of claim 1, further comprising:
allotting, by the consignor, the designated consignee an allotment of purchased items that are packaged independently to different customers to be delivered to the designated consignee.

9. The method of claim 1, further comprising:
alerting, by the consignor, the designated consignee that it has been selected by the at least one customer subsequent to completing the virtual checkout process;
alerting, by the consignor, the customer that the carrier has delivered the purchased items of the customer;
wherein alerting the customer that the carrier has delivered the purchased items of the customer occurs subsequent and in response to the consignor receiving a notification from the carrier that the purchased items were delivered to the designated consignee.

10. The method of claim 1, further comprising:
assigning, by the consignor, a reliability index of the designated consignee prior to delivery of the purchased items of the customer, wherein the reliability index is adapted to provide the carrier or the customer a reliability rating of the designated consignee that the designated consignee will successfully transfer the purchased items to the customer; and
prohibiting future customers from selecting the designated consignee during the virtual checkout process if the reliability index falls below a pre-selected threshold as set by the consignor.

11. The method of claim 10, further comprising:
billing the customer, by the consignor, for shipping services of the carrier to deliver the purchased items to the designated consignee;
wherein a billing amount varies in response to the reliability index, wherein the billing amount for a designated consignee with a higher reliability index is greater than the billing amount for another designated consignee with a lower reliability index.

12. The method of claim 1, further comprising:
channeling customers to a plurality of designated consignees during the checkout process in response to a location determination performed at a customer terminal, wherein the customers are channeled to the plurality of designated consignees that are in closest proximity to the customer as determined by the location determination.

13. The method of claim 1, further comprising:
comparing, by the consignor, a request by the customer to deliver the package or parcel of purchased items to the designated consignee with a pre-selected availability of the designated input into a third party application cooperating within the virtual checkout module of the consignor; and
enabling the customer to select the designated consignee when the pre-selected availability of the designated consignee matches the request by the customer and preventing the customer from selecting the designated consignee when the pre-selected availability of the designated consignee does not match the request by the customer.

14. The method of claim 1, further comprising:
transferring, from the consignor, a data packet containing location information of the designated consignee and shipping information for the packaged items to the carrier, wherein the data packet is transferred prior to the carrier shipping the package;
effecting the carrier to confirm that the purchased items are to be delivered to the designated consignee and later retrieved by the customer.

15. The method of claim 1, further comprising:
determining, by the consignor, a nearest available designated consignee in response to the customer selecting a shipping preference to the designated consignee during the virtual checkout process;
displaying a plurality of designated consignees to the customer prior to completing the virtual checkout process, wherein displaying the plurality of designated consignees may be accomplished through one of a list format and a map format.

16. The method of claim 1, further comprising:
encrypting, by the consignor, pre-selected information about the designated consignee and preventing the customer from receiving or viewing the encrypted pre-selected information during the virtual checkout process;
maintaining the encryption of the pre-selected information and preventing the customer from receiving or viewing the encrypted pre-selected information after completion of the virtual checkout process.

17. The method of claim 1, further comprising:
featuring one designated consignee as a preferred designated consignee during the checkout process in response to the one designated consignee subscribing to service in a third party application having an application program interface (API) cooperating with the virtual checkout module of the consignor;
hyperlinking, by the consignor, a profile of the one featured designated consignee displayed in a customer terminal during the virtual checkout process with a profile of the designated consignee maintained on a remote third party application or server.

18. The method of claim 1, further comprising:
predefining, by the consignor, items for sale that are able to be shipped to the designated consignee, wherein the predefinition is performed prior to offering the items for sale;
offering a discount to the customer during the virtual checkout process to ship the purchased items to the designated consignee that is identified as available through a remote third party application cooperating with the virtual checkout module of the consignor;
discounting a price of the transaction in response to the customer accepting the offer;
paying the designated consignee to receive the purchased items on behalf of the customer, wherein the designated consignee is paid by, at least indirectly, the consignor, wherein funding the payment to the designated consignee is accomplished by, at least indirectly, the customer who provides funding to the consignor which then pays the designated consignee.

19. The method of claim 1, further comprising:
interfacing, in the virtual checkout module, a map or list of designated consignees with a database of designated consignees hosted or stored on a remote server of a third party application;
locating a nearest designated consignee during the virtual checkout process in response to a customer selection to ship the purchased items to the designated consignee and not ship the purchased items to a home address, work address, or a friend or relative's home address;
optimizing a display in a customer terminal used to complete the virtual checkout process of the nearest designated consignee based on closest distance and ratings of the designated consignee provided by other customers.

20. At least one non-transitory computer readable storage medium having instructions encoded thereon that, when executed by at least one processor, implement operations to activate an operator as a designated consignee to receive a package or parcel containing a purchased item by a customer from a consignor, the operations including:
set, by the operator as the designated consignee, an available timeframe during which a carrier may deliver the package or parcel to the designated consignee on behalf of the customer;
populate the available timeframe into a checkout module associated with a virtual storefront of the consignor; and
effectuate the customer to have the consignor instruct the carrier to deliver the package or parcel during the available timeframe; and
an on-demand timeframe different the from available timeframe that is activated by the designated consignee in response to an execution call to notify the consignor or the carrier that the designated consignee is available to receive packages or parcels on behalf of customers.
